(19) United States
(12) Patent Application Publication
(10) Pub. No.: US 2004/0120353 A1
(43) Pub. Date: Jun. 24, 2004

(54) Method and apparatus for double data rate serial ATA phy interface

(76) Inventors: Ook Kim, Palo Alto, CA (US); Sungjoon Kim, Cupertino, CA (US); Robert Norman, Blaine, WA (US); Chi Wai Ho, Fremont, CA (US); Frank Lee, San Jose, CA (US); Dongyun Lee, San Jose, CA (US); Gijung Ahn, Sunnyvale, CA (US); Seung-Ho Hwang, Palo Alto, CA (US)

Correspondence Address: PERKINS COIE LLP, P.O. BOX 2168, MENLO PARK, CA, 94026, US

(21) Appl. No.: 10/658,590

(22) Filed: Sep. 8, 2003

Related U.S. Application Data
(60) Provisional application No. 60/409,367, filed on Sep. 6, 2002.

(51) Int. Cl. H04J 3/06

(52) U.S. Cl. 370/503

(57) ABSTRACT

A method for multiplexing control signals for disk drives includes developing parallel control signals and developing serial control signals. At least one of the parallel control signals and the serial control signals are coupled to at least one of a parallel hard disk drive and a serial hard disk drive by a common control bus.

### CROSS REFERENCE TO RELATED APPLICATIONS

This application claims the benefits of co-pending U.S. Provisional Patent Application No. 60/409,367 filed on Sep. 6, 2002, and is incorporated herein by reference.

### FIELD OF THE INVENTION

The present invention relates to PC motherboard chipsets and more particularly to connection schemes between PC motherboard chipsets and hard disk drives.

### BACKGROUND OF THE INVENTION

ATA (advanced technology attachment or AT attachment—a reference to AT/286 computers) has been the standard internal storage interconnect for desktop and mobile computers since the 1980's. ATA's relative simplicity, low cost and high performance has enabled it to remain in use for an extended period of time.

Despite these advantages, a number of limitations exist. ATA uses a 5-volt signal requirement. Use of this standard is becoming incompatible with cutting edge integrated circuits that are designed to operate at a lower voltage. Also, ATA requires a high pin count which necessitates a bulky ribbon cable. The high pin count is problematic for chip design and the ribbon cable impedes airflow which makes thermal design difficult. Finally, ATA data transfer rate is limited to about 100 megabytes/second maximum.

Due to those limitations, a new standard has been defined for the next generation ATA. This standard is called serial ATA or SATA for short. This new standard allows for data transfer speeds starting at 150 megabytes/second and ultimately up to 600 megabytes per second. Advantageously, it also employs a much thinner cable with a smaller pin count.

As the new SATA standard gains widespread use, undoubtedly there will be computer users who may wish to use both older style ATA Hard Disk Drives (HDDs) and SATA HDDs in one system. FIG. 1 illustrates a prior art computer system 10 that employs ATA style HDDs. Included in the system is a CPU 20, a motherboard chipset or South Bridge 30, an ATA bus 40, a first ATA HDD 50 and a second ATA HDD 60. In the ATA configuration, only one ATA bus is used and only 1 HDD can communicate to the CPU at a time.

FIG. 2 shows a computer system 70 that uses the newer SATA configuration. Similar to the ATA setup, there is a CPU 20 and a South Bridge interface 30. Also included is a first SATA HDD 80 and a second HDD SATA 90. Unlike the ATA configuration, each SATA HDD 80 and 90 are connected directly to the South Bridge via separate SATA links 90 and 100.

It is readily recognized that, in the prior art, in order to use both style connectors in one system, more cables would need to be added or the SATA and ATA type connectors would need to be combined into one larger, more complex, more expensive and unwieldy cable.

Accordingly, what is needed is a way easily connect an SATA HDD into an existing system containing ATA HDD's without having to add more cables or add to the pin count of the existing ATA connector.

### SUMMARY OF THE INVENTION

The present invention provides a method and apparatus for adding a SATA HDD into an existing system containing ATA HDDs without having to add more cables or add to the pin count of the existing ATA connector.

A method for multiplexing control signals for disk drives, in accordance with an embodiment of the present invention, includes developing parallel control signals and developing serial control signals. At least one of the parallel control signals and the serial control signals are coupled to at least one of a parallel hard disk drive and a serial hard disk drive by a common control bus.

A disk drive controller, in accordance with another embodiment of the present invention, includes parallel logic developing parallel control signals and serial logic developing serial control signals. Also included is a multiplexer that couples at least one of the parallel control signals and the serial control signals to a common bus.

A method for doubling a data rate on a disk drive serial bus, in accordance with yet another embodiment of the present invention, includes developing a sampling data clock, developing a first data stream at a base data rate and developing a second data stream at the base data rate. The first data stream is multiplexed to a disk drive serial bus on a rising edge of the base data clock and the second data stream is multiplexed to the disk drive serial bus on a falling edge of the base data clock, whereby the disk drive serial bus carries both the first data stream and the second data stream at effectively double the base data rate.

A method for encoding additional commands in a coding standard, in accordance with a final embodiment of the present invention, includes determining at least one invalid command in used coding space of a coding standard; and determining unused coding space. The at least one invalid command is encoded in the used coding space and at least one command is encoded in the unused coding space.

An advantage of the present invention is that serial ATA hard disk drives can be added to an existing system utilizing ATA hard disk drives without adding to the pin count of a chipset. Additionally, the present invention provides for double data rate communication to serial ATA hard disk drives and for encoding additional commands in an unused space of a coding standard.

These and other advantages of the present invention will become apparent to those skilled in the art after reading the following descriptions and studying the various figures of the drawings.

### BRIEF DESCRIPTION OF THE DRAWINGS

FIG. 1 is a partial block diagram of a prior art computer system that employs ATA style HDD's.

FIG. 2 is a partial block diagram of a computer system that employs SATA style HDDs.

FIG. 3 is a partial block diagram of a computer system that utilizes both ATA and SATA style HDDs, in accordance with an embodiment of the present invention.

FIG. 4 is a partial block diagram of a computer system that utilizes both ATA and SATA style HDDs, in accordance with another embodiment of the present invention.

FIG. 5A is a circuit diagram for generating TxD and TBC signals, in accordance with the present invention.

FIG. 5B is an alternate circuit diagram for generating TxD and TBC signals, in accordance with the present invention.

FIG. 5C is a timing diagram for TxD and TBC, in accordance with the present invention.

FIG. 6 is a circuit diagram which generates TxD and TBC for a multiplexer, in accordance with the present invention.

FIG. 7 is a block diagram of the PHY portion of the TBC and the TxD block, in accordance with the present invention.

FIG. 8 is a timing diagram of RBC0, RBC1 and RxD, in accordance with the present invention.

FIG. 9A is a block diagram illustrating a flow of data between a link and a PHY, in accordance with the present invention.

FIG. 9B is a block diagram illustrating an implementation for generating an RBC signal, in accordance with the present invention.

FIG. 9C is a timing diagram of RBC0 and RBC1 timing relationships in RXD and RBC calibration phases, in accordance with the present invention.

FIG. 10 is a flowchart illustrating a method of calibrating differing clocks, in accordance with the present invention.

FIG. 11 is a timing diagram illustrating a DATA_READY signal generation, in accordance with the present invention.

FIG. 12 is a flowchart illustrating a method encoding additional information in an unused coding space of a coding standard, in accordance with the present invention.

FIG. 13A is a flowchart illustrating a method for encoding additional information in an unused coding space of an 8B10B encoding scheme, in accordance with the present invention.

FIG. 13B is an illustration of encoding additional information in an unused coding space of an 8B10B encoding scheme, in accordance with the present invention.

FIG. 14 is a block diagram illustrating pin encoding, in accordance with an embodiment of the present invention.

FIG. 15 is a timing diagram illustrating a method of transmitting a double data rate, in accordance with an embodiment of the present invention.

FIG. 16 is a timing diagram illustrating an SDR case when channel 0 is active for a power saving mode, in accordance with the present invention.

FIG. 17 is a timing diagram illustrating an SDR case when channel 1 is active for a power saving mode, in accordance with the present invention.

FIG. 18 is a timing diagram illustrating RBC0 and RBC1 when channel 0 is active for a power saving mode, in accordance with the present invention.

FIG. 19 is a timing diagram illustrating RBC0 and RBC1 when channel 1 is active for a power saving mode, in accordance with the present invention.

FIG. 20 illustrates a state diagram for channel 0 and channel 1 active/inactive modes, in accordance with the present invention.

FIG. 21 is a block diagram of an SATA PHY chip, in accordance with the present invention.

FIG. 22 is a detailed block diagram illustrating the hookup of the Rx encoders with a two-channel interface, in accordance with the present invention.

FIG. 23A is a detailed block diagram illustrating the hookup of the Tx encoders with a two-channel interface, in accordance with the present invention.

FIG. 23B is a more detailed block diagram illustrating the hookup of the Tx encoders, in accordance with the present invention.

### DETAILED DESCRIPTION OF THE INVENTION

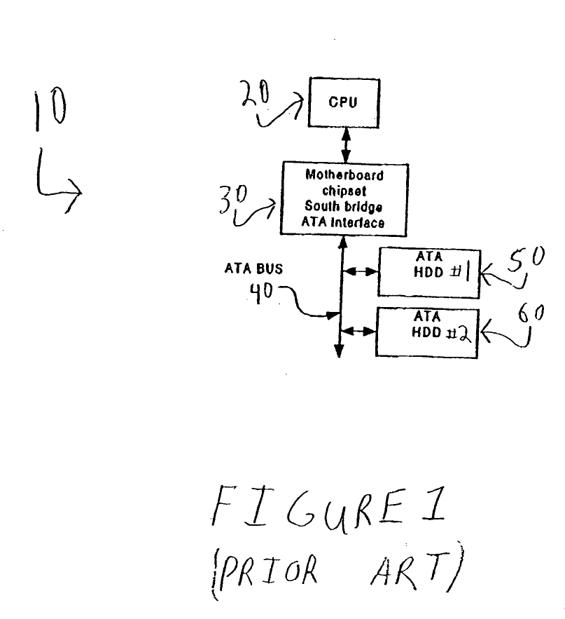

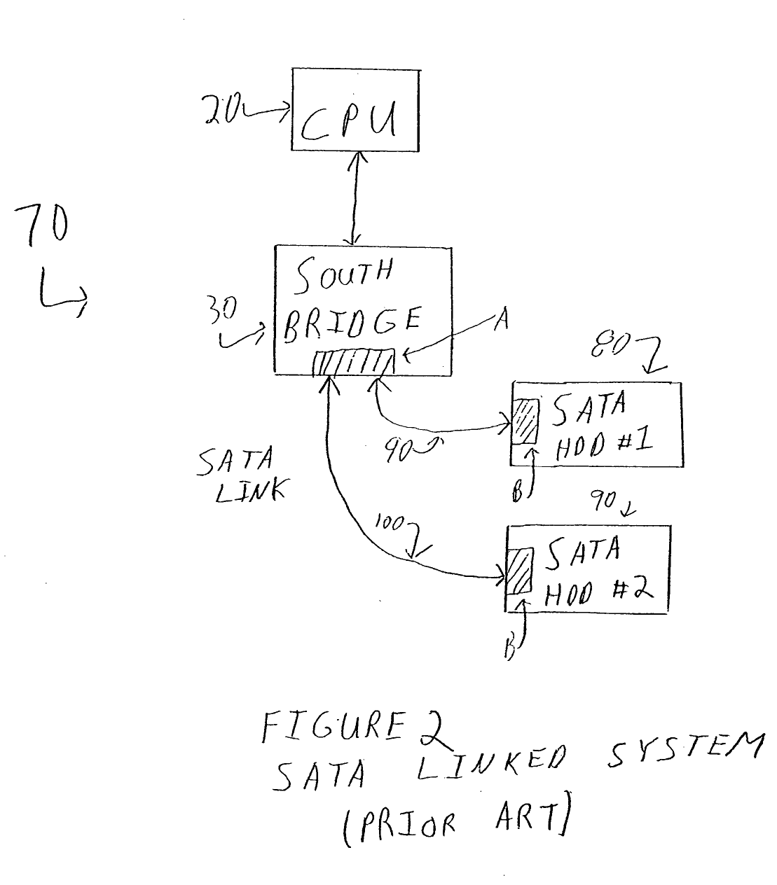

FIGS. 1-2 were previously described with reference to the prior art.

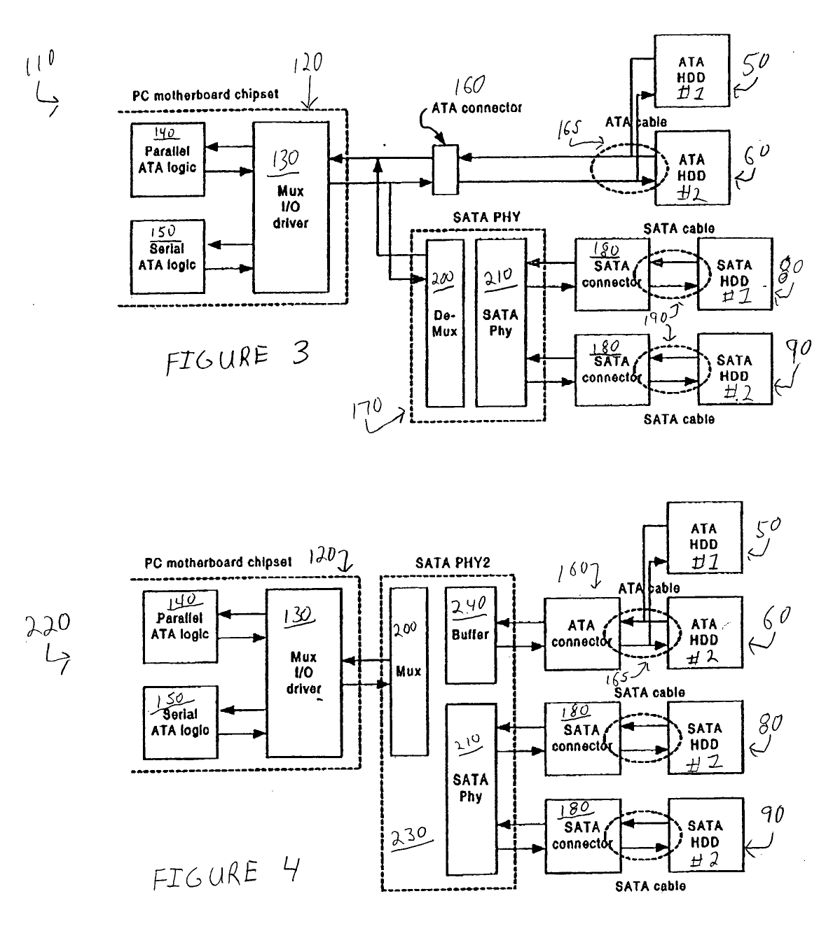

FIG. 3 is a partial block diagram 110 of a computer system that utilizes both ATA and SATA style HDDs, in accordance with an embodiment of the present invention. Included is a PC motherboard chipset 120 that contains a multiplexer 130 that multiplexes signals from parallel ATA logic 140 and serial ATA logic 150. Also included is an ATA connector 160 that connects to ATA HDD's 50 and 60 via an ATA cable 165. Additionally, an SATA PHY 170 is coupled to the multiplexer 130 and SATA connectors 180. Connectors 180 are coupled to SATA HDD's 80 and 90 via SATA cables 190. Within the SATA PHY 170, there is also a demultiplexer 200 and an SATA PHY sub-block 210.

SATA PHY 200 can be configured as an interface between a chipset 120 and an SATA serial data HDD (80 and 90) as shown in FIG. 3. In this case, the chipset 120 has a built-in MUX 130 to control the data stream, which is used either for the ATA logic 140 or for the SATA logic 150. For the ATA logic 140, the internal MUX 130 operates at a very high speed and there is very little effect on the ATA operation. In the SATA logic 150, it uses the same ports to communicate with SATA PHY 170. However, in this case, the interface is no longer employing the ATA interface signaling scheme.

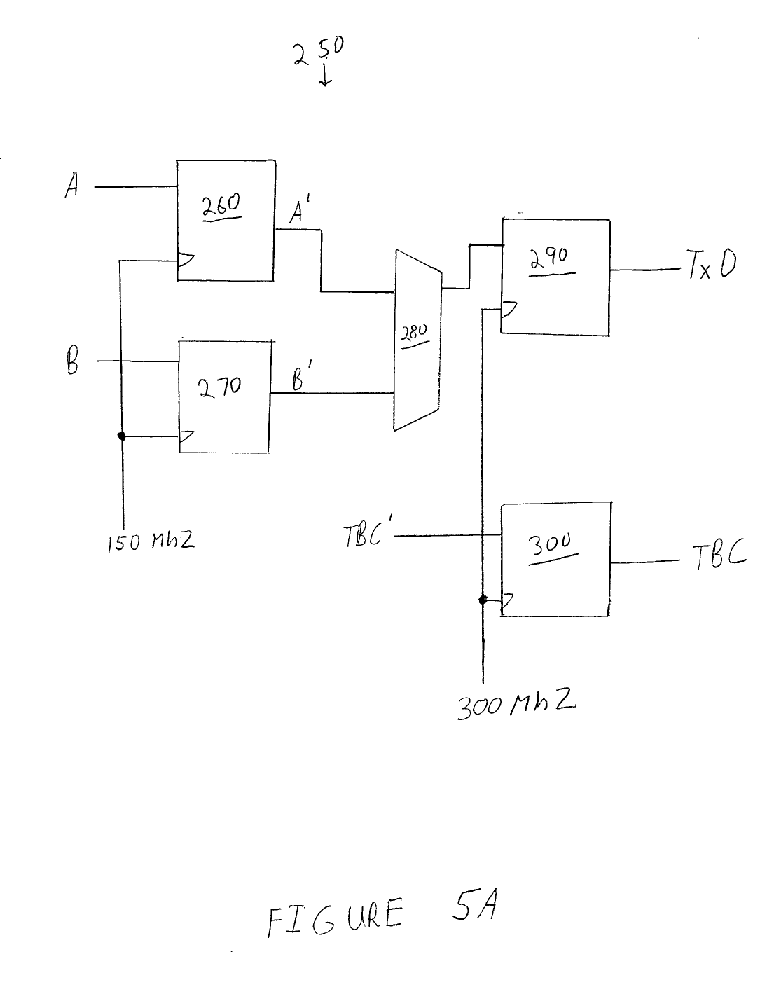

FIG. 4 is a partial block diagram 220 of a computer system 220 that utilizes both ATA and SATA style HDDs, in accordance with another embodiment of the present invention. In this embodiment, the ATA signals are routed through the SATA PHY 230 via the buffer 240.

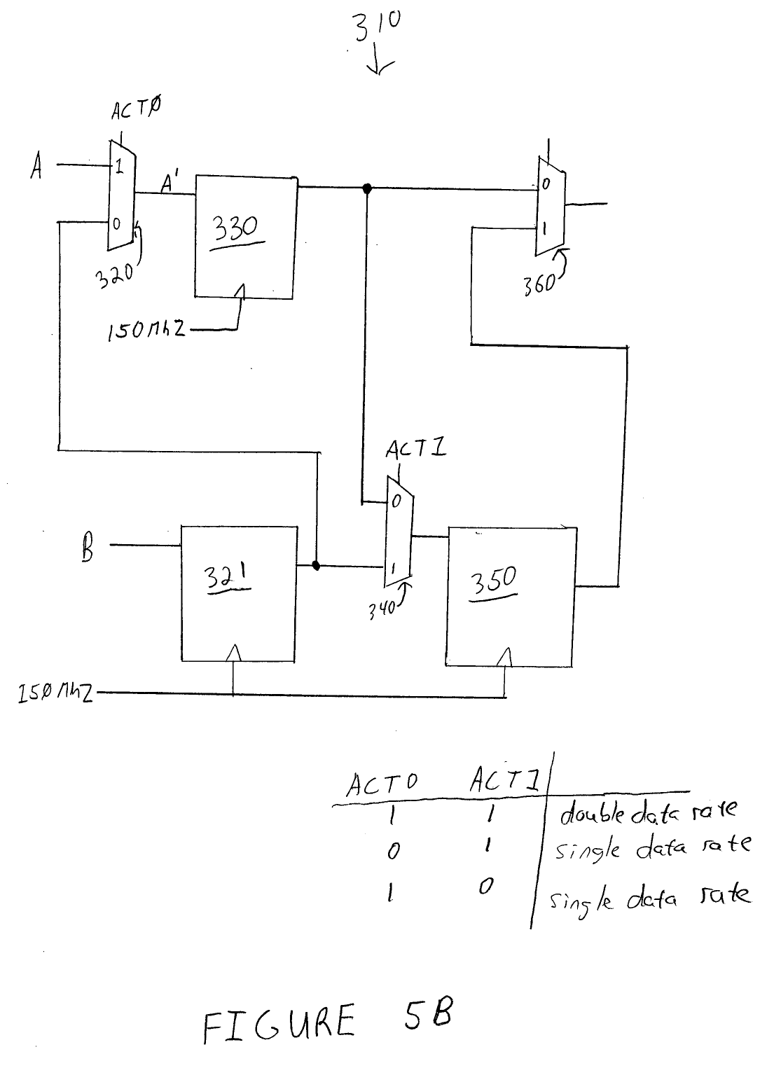

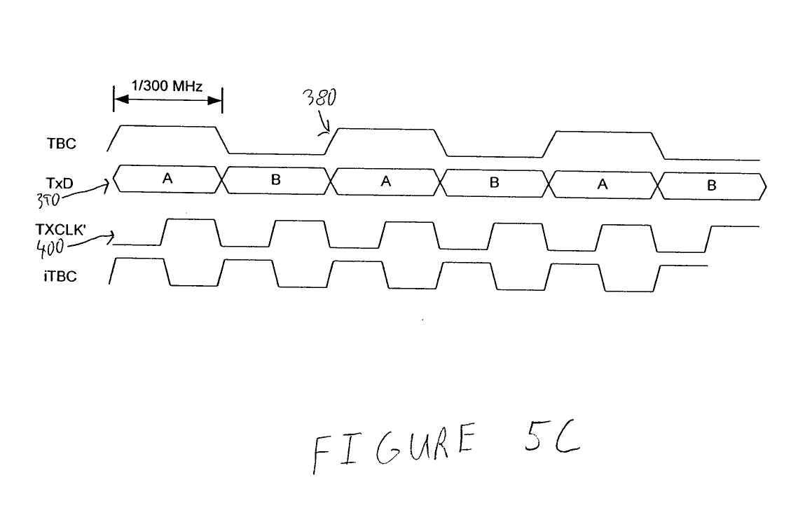

FIG. 5A is a circuit diagram 250 for generating TxD (Tx data) and TBC (Transmi Byte Clock) signals, in accordance with the present invention. Flipflops(namely FF) 260 and 270 are coupled to channels A and channel B, respectively, as well as a 150 MHz clock. Channels A and B refer to two separate SATA HDD's. FFs 260 and 270 produce signals A′ and B′ that are subsequently coupled to Muliplexer(namely Mux) 280. The output of mux 280 is coupled to FF 290 that is also coupled to a 300 MHz clock and produces the TxD output. Also included is a FF 300 that is coupled to a TBC′ input and the 300 MHz clock and FF 300 produces a TBC output.

FIG. 5B is an alternate circuit diagram for determining when to use a double data rate, in accordance with the present invention. Mux 320 is coupled to channel A, an output of FF 321 and ACT0. FF 330 is coupled to the output (A′) of flipflop 320 and a 150 MHz clock. Similarly, FF 321 is coupled to channel B and the 150 MHz clock. Additionally, mux 340 is coupled to the outputs of FFs 321 and 330. Finally, FF 350 is coupled to an output of mux 340 and mux 360 is coupled to the outputs of FFs 350 and 330. In operation, when both ACT0 and ACT1 delivers a high signal (1), double data operation is employed.

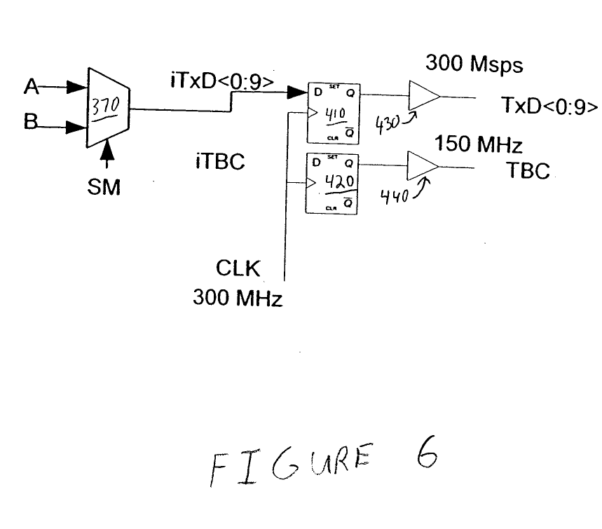

Referring to FIGS. 5C and 6, FIG. 5C is a timing diagram for TxD and TBC, in accordance with the present invention and FIG. 6 is a circuit diagram which generates TxD and TBC for multiplexer 130 (not shown), in accordance with the present invention. The Tx block in the PC motherboard chipset (LINK) 120 is generated by mux 370. As long as the TBC clock 380 is generated by the same FFs 410 and 420, the data(TxD) and clock (TBC) 390 will be aligned with each other. TxD 390 is sent to PHY (170/not shown). PHY 170 has a built-in PLL which is used for transmitting low jitter, high speed serial data. The PHY extracts TBC edge and extracts an optimum clock TXCLK′ 400. With this scheme, two channel data can be also sent in a single ATA bus as well. With the high duration of the clock, data ‘A’ is sent and with the low duration of the clock, data ‘B’ is sent. The PLL can also be used for extracting the optimum clock phases for TXD 390 data latching point.

With further reference to FIG. 6, channels A and B are coupled to mux 370. FFs 410 and 420 are both coupled to a 300 MHz clock CLK. FF 410 is also coupled to an output of mux 370. In addition, buffers 430 and 440 are coupled to outputs of FFs 410 and 420, respectively.

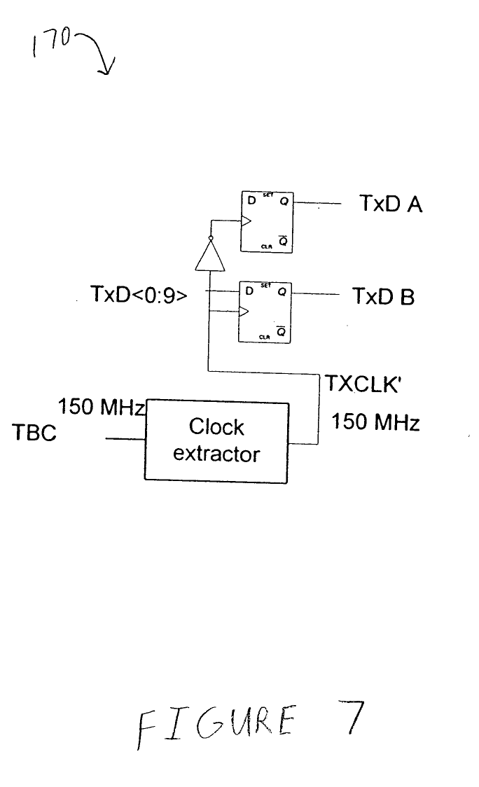

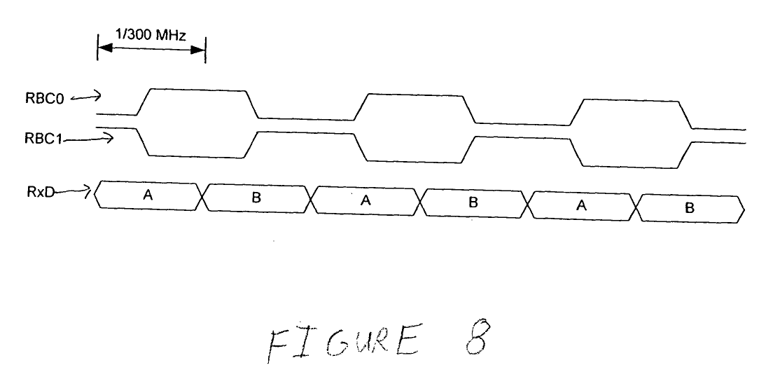

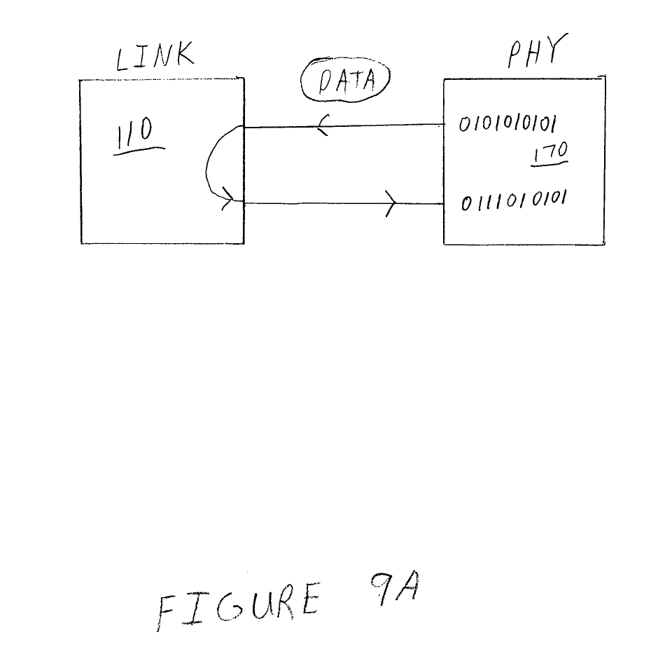

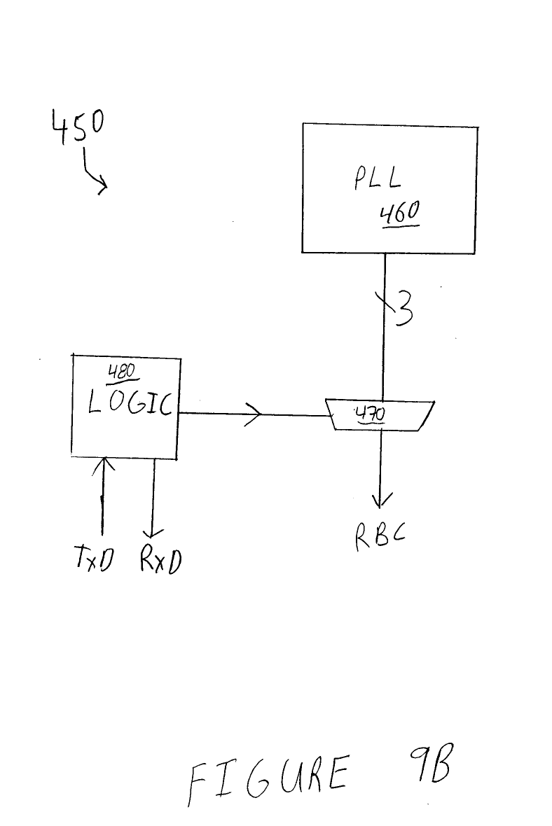

Referring to FIGS. 7 and 8, FIG. 7 is a block diagram of the PHY portion 170 of the TBC and the TxD block and FIG. 8 is a timing diagram of RBC0, RBC1 and RxD, both in accordance with the present invention. For the receiving portion of the data, two clock signals (RBC0 and RBC1) are generated to latch incoming data. RBC0 is used for extracting ‘A’ block data and RBC1 is used for extracting ‘B’ block data.

By using this scheme, two channels of SATA data can be sent on a single data line. For the generation 1 case defined in SATA specification, 150 Mbytes/sec data is transferred from LINK/chipset 120 to PHY 160, by using double data rate transmission, 300 Mbytes/sec total data speed is achieved. For the generation 2 case, total 600 Mbytes/sec total data speed is also achieved by having two 300 Mbytes/sec data channels in the link. Even though the chipset 120 cannot deliver 600 Mbytes/sec for a general case, it can transmit data within such condition as short distance and minimum capacitance loading. Also, by having calibration phases during setup link time, test patterns can be transmitted and PHY detects channel skew between clocks and data, as will be discussed subsequently. By having high-speed data input port for this link in the PHY block, reliable transmission can be achieved by using moderate data and clock driver in the chipset.

In the RXD section, two clock signals such as RBC0 and RBC1 are generated from the PHY as shown in FIG. 8. These two clock lines signals are both channel A and channel B. As the link speed becomes higher, the optimum latching point for the RXD is very important to make a solid link between PHY 120 and LINK 170. To make it more robust over various operation conditions and PCB traces, a calibration scheme can be used.

In view of the foregoing, it will be appreciated that a method for multiplexing control signals for disk drives includes developing parallel control signals and developing serial control signals. At least one of the parallel control signals and the serial control signals are coupled to at least one of a parallel hard disk drive and a serial hard disk drive by a common control bus.

It will also be appreciated that a disk drive controller includes parallel logic developing parallel control signals and serial logic developing serial control signals. Also included is a multiplexer that couples at least one of the parallel control signals and the serial control signals to a common bus.

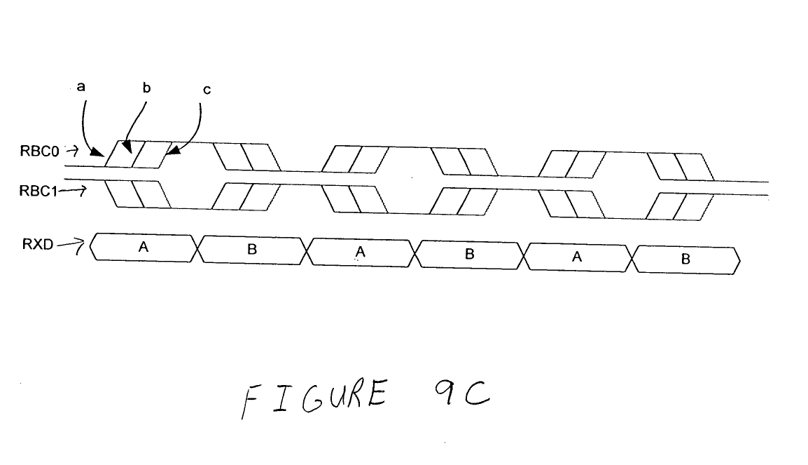

FIG. 9A is a block diagram illustrating a flow of data between a link 110 and a PHY 170, in accordance with the present invention. As can be seen, binary data flows between the link 110 and PHY 170. In order to keep the flow of data flowing correctly, calibration between the two blocks 110 and 170 needs to occur.

FIG. 9B is a block diagram 450 illustrating an implementation for generating an RBC signal, in accordance with the present invention. The RBC signal is used as part of the calibration technique that will be explained in more detail, subsequently. Included in block diagram 450 is a PLL 460 coupled to a flipflop 470. Flipflop 470 is also coupled to a logic 480. Logic 480 responsive to a TxD signal and operative to develop an RxD signal.

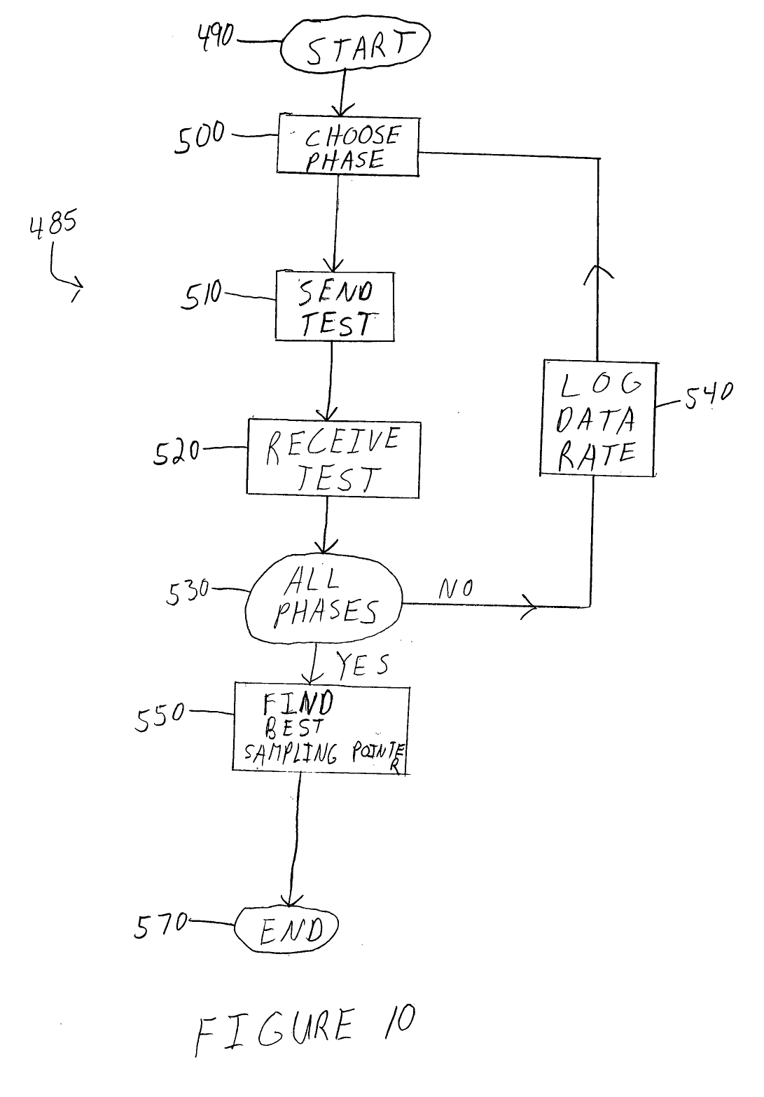

FIG. 9C is a timing diagram of RBC0 and RBC1 timing relationships in RXD and RBC calibration phases, in accordance with the present invention. RBC0,1 is moved relative to the RXD in the calibration phase. In this mode, LINK 110 re-transmits received data through TX channel. By using adequate calibration test patterns, generated by the PHY, PHY can detect the optimum RBC0,1 and RXD data relationship. It can also detect channel skews between RBC0,1. The start and end of calibration can be timer operated such as shown in FIG. 10. However, some signals such as one bit of RXD or other signal bits can be used for this purpose as well.

FIG. 10 is a flowchart illustrating a method 485 of calibrating differing clocks, in accordance with the present invention. After a start operation 490, a phase is chosen at operation 500. A test is then sent for the chosen phase at operation 510 and the test is received at operation 520. At a decision point 530, it is checked to see if all phases have been tested. If not, the data rate is logged at operation 540 and the next phase is chosen at operation 500. Operations 510, 520 and 530 are then repeated. After all phases have been tested, the best edge for RBC has been calculated. One algorithm for this is to log those phases which has a specific bit errors, then the optimum phase is the mean value of phases, where bit error rate is zero, at operation 550. This has been shown in FIG. 10B. The method then ends at operation 570.

Other control signals are also required between PHY 170 and LINK 120. These signals are as follows:

COMMA: signals the detection of K28.5 signal defined 8B10B coding, PHY to LINK

PARTIAL/SLUMBER: signals partial/slumber states, LINK to PHY

CLOCK: main system clock, PHY to LINK

COMINIT/COMWAKE: OOB (out of band) signaling

RESET: SATA related RESET

DAZATA READY: For handshaking purposes

TX_DATA_EN: For sending OOB data in Tx, LINK to PHY

Other signals: status report between PHY and LINK

FIG. 11 is a timing diagram illustrating a DATA_READY signal generation, in accordance with the present invention. For each channel of SATA devices, those signals can also be multiplexed. For example, DATA_READY signal is used for signaling whether the RX data is valid or noting this signal, the rate difference between RX and Tx can be controlled and only one synchronous clock can be used for both Rx and Tx data. In the SATA implementation, a redundant ALIGN primitive is inserted. The PHY can either insert or delete these signals. Also, in order to make the deletion more simple, an additional data signal named DATA_READY can be used for both channels.

For lower frequency signals, they can be multiplexed by combining several consecutive bits. In this case, a characteristic pattern can be used to multiplex those signals within normal data signals which is 8B10B encoded signal. For example, by combining 4 bits, signal activity can be defined as follows:

1111: alignment pattern

OXYZ: X, Y, Z is allocated for each bits for signaling.

In this case, each normal word except for the alignment pattern starts with o. X is used for the signal X, y is used for signal Y and Z is used for signal Z. For example X is RESET, Y and PARTIAL and Z is SLUMBER.

0000: RESET is low, PARTIAL is low and SLUMBER is low

0001: RESET is low, PARTIAL is low and SLUMBER is high

By using these methods, the total number of signals to be used for supporting 2 channel SATA PHY can be minimized. One example for the usage of pins is shown in table 1.

TABLE 1
Pin number usage

| | Number | |
|---|---|---|
| Name | of pins | Purpose |
| TxD | 10 | LINK to PHY 10-bit data |
| TBC | 1 | Transmit byte clock |
| RXD | 10 | PHY to LINK 10-bit data |
| RBC0, RBC1 | 2 | PHY to LINK byte clock |
| CTRL1 | 1 | LINK to PHY control signals |
| CTRL2 | 1 | PHY to LINK control signals |
| DATA_READY | 1 | DATA_READY signals |
| Total | 26 | |

However, by using unused coding bytes for 8B10B coding in the TXD and RXD, those CTRL1, CTRL2 and DATA_READY can also be implemented. Then the minimum set of data is only 25 pins. This will greatly reduce the overhead to implement both SATA channel and ATA channels in a chipset.

In the conventional ATA scheme, only one of the master or slave can have control of the ATA bus. By allowing two simultaneous communications of data, this method can boost the transport speed between the CPU and the HDD by a factor of two.

In view of the foregoing, it will be appreciated that a method for doubling a data rate on a disk drive serial bus includes developing a sampling data clock, developing a first data stream at a base data rate and developing a second data stream at the base data rate. The first data stream is multiplexed to a disk drive serial bus on a rising edge of the base data clock and the second data stream is multiplexed to the disk drive serial bus on a falling edge of the base data clock, whereby the disk drive serial bus carries both the first data stream and the second data stream at effectively double the base data rate.

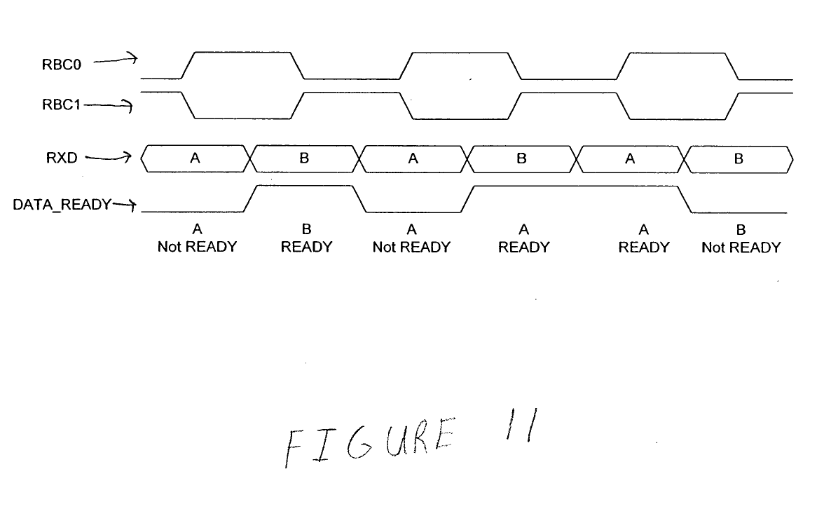

FIG. 12 is a flowchart illustrating a method 580 encoding additional information in an unused coding space of a coding standard, in accordance with the present invention. After a start operation 590, an unused coding space in a coding standard is determined at operation 600. Some of the bits are then forced into the unused coding space at operation 610 and some of the remaining bits are used as an additional communication channel at operation 620. Method 580 then ends at operation 630.

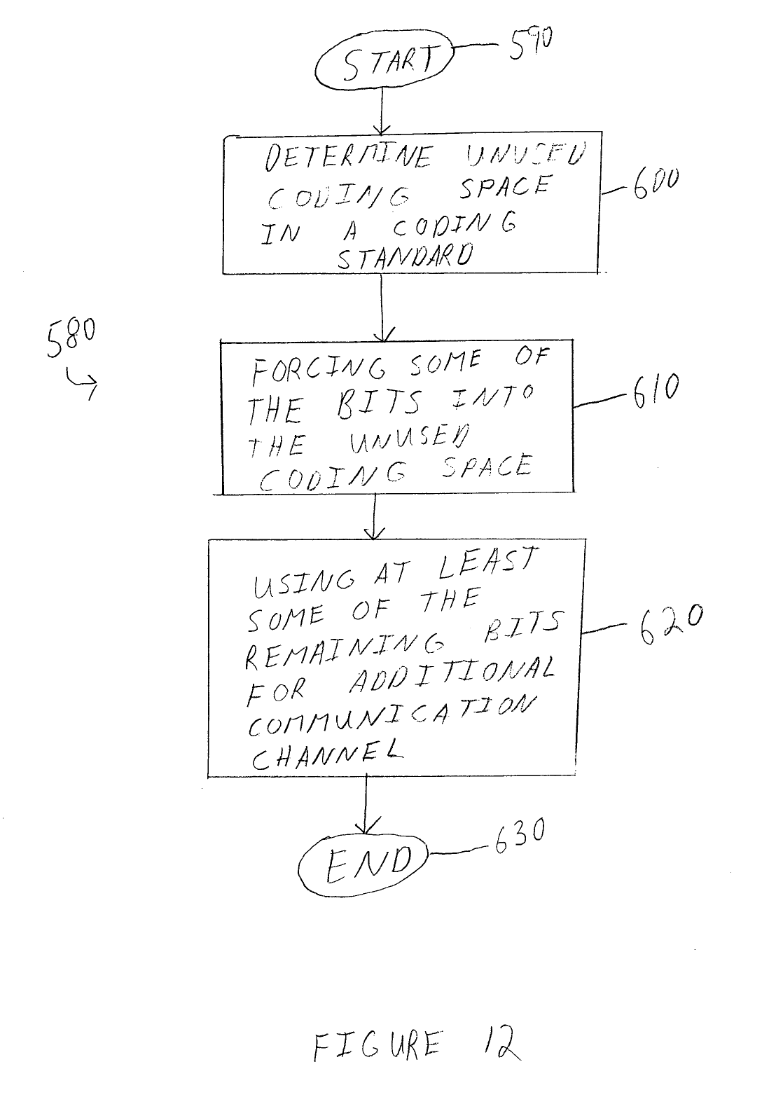

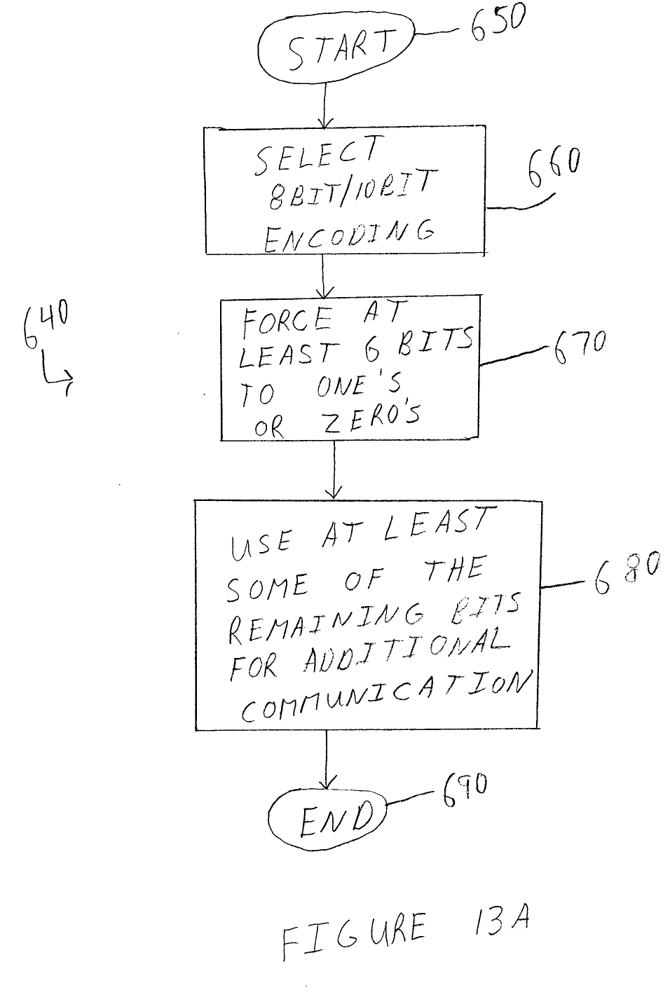

FIG. 13A is a flowchart illustrating a method 650 for encoding additional information in an unused coding space of an 8B10B encoding scheme, in accordance with the present invention. After a start operation 650, an 8 bit/10 bit encoding scheme is selected at operation 660. At least six bits are forced to either all one's (“111111”) or all zero's (“000000”), at operation 670. At least some of the remaining bits are then used for an additional communication channel at operation 680. Method 640 then completes at operation 690.

FIG. 13B is an illustration of encoding additional information in an unused coding space of an 8B10B encoding scheme, in accordance with the present invention. In example 700, the first six bits were forced to “one”. As previously mentioned, the occurrence of six consecutive one's signal that at least a portion of the remaining coding space is used for additional information. In this particular case, the additional information takes the form of “ABCD”. Similarly, in example 710, the first six bits were forced to “zero” and therefore the remaining coding space can be used to communicate additional data. It will be appreciated by one skilled in the art that the occurrence of the six consecutive one's or zero's can take place at any location within the coding space and the remaining unused portion can be used as the additional information channel.

In view of the foregoing, it will be appreciated that a method for encoding additional commands in a coding standard includes determining at least one invalid command in used coding space of a coding standard; and determining unused coding space. The at least one invalid command is encoded in the used coding space and at least one command is encoded in the unused coding space.

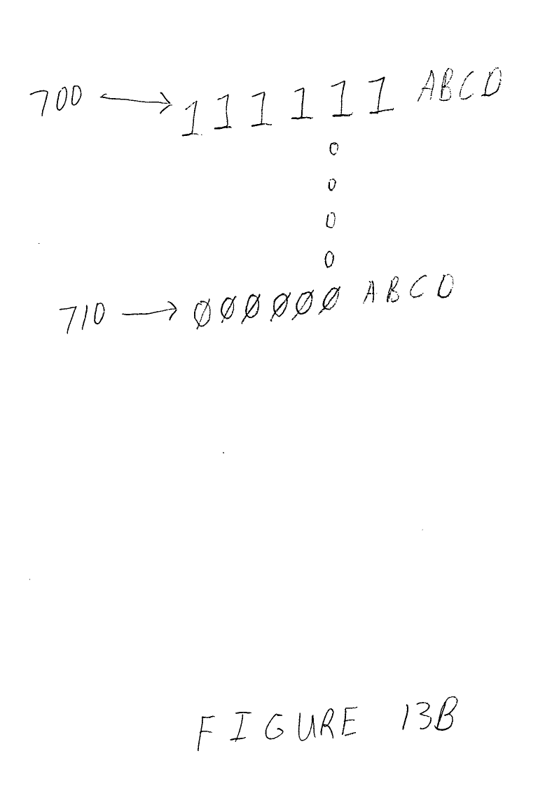

FIG. 14 is a block diagram 720 illustrating pin encoding, in accordance with an embodiment of the present invention. Included in block diagram 720 is a PHY 730 for providing communication between a dual-channel SATA PHY and a southbridge 30 with a SATA link and transport layer. The connections between PHY 730 and the southbridge 30 include TxD, TBC, RxD, RBC[0:1], RX_DATA_VALID, COM_DET, ASIC_CK, RESET and REF. Also included in a system clock 740. The encircled connections labeled as SATALITE interface are the connections that utilize multiplexed signals.

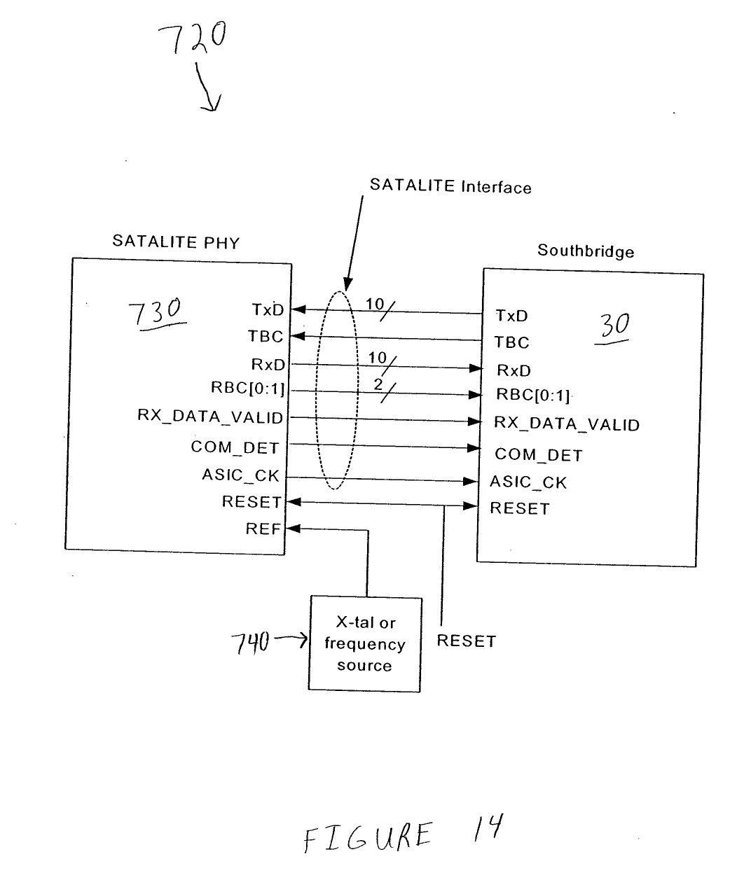

FIG. 15 is a timing diagram 750 illustrating a method of transmitting a double data rate (DDR), in accordance with an embodiment of the present invention. The data interface between the PHY 730 and the southbridge 30 runs at a double data rate. Since the bandwidth of operating two PHY's 730 (only one is shown for simplicity) at the first generation SATA speed of 1.5 gigabytes per second would require a total of 3.0 gigabytes per second. Therefore, a 10-bit bus would need to be sampled at 300 MHz with a conventional single data rate (SDR) implementation. With DDR, a 150 MHz clock is used and both edges of the clock is sampled.

For the transmit case, the rising and falling edges of the TBC (transmit byte clock) and TxD (Tx data) are aligned. A high period 760 of the TBC signals TxD channel 0 data. Conversely, a low period 770 of the TBC indicates TXD channel 1 data.

For the receive case, only the rising edges are used for sampling. The rising edge 780 of RBC0 (receive byte clock 0) is used to latch RxD (Rx data). Similarly, the rising edge 790 of RBC1 is used RxD for channel 1.

Referring back to FIG. 14, the PHY 730 is capable of incorporating two SATA channels. However, it is possible that only one SATA device would be connected. Therefore, given that situation, it is possible to employ various power savings techniques. Most of the power consumption of the SATALITE interface is due to I/O switching. The DDR mode is adopted to multiplex two SATA data streams and if only one SATA device is present, power would be wasted multiplexing for a non-existent second SATA device. If only one SATA device is connected, then TxD and RxD do not need to switch on the half cycles assigned to the unconnected channel. Therefore a SDR mode is employed when only one SATA device is connected.

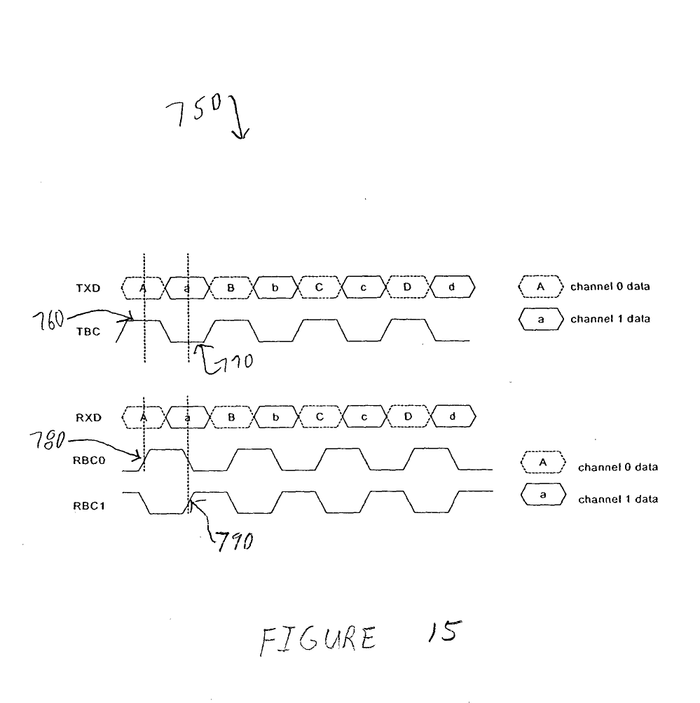

In the interest of simplification, however, the TBC and RBC clocks are kept at the same rate and will now be further explained. FIGS. 16-19 illustrate timing diagrams for an SDR case when channel 0 is active, an SDR case when channel 1 is active, illustrating RBC0 and RBC1 when channel 0 is active and RBC0 and RBC1 when channel 1 is active, respectively, all for a power saving mode in accordance with the present invention. Referring to FIGS. 16 and 18, only channel 0 is connected and channel 0 data is sampled on the high period 750 of TBC and the rising edge 760 of RBC0. Instead of switching the data to nulls for channel 1 on the low period 770 of TBC or the falling edge 780 of RBC0, the TxD/RxD pins (not shown) maintain the same data as sent for channel 0. As a result, toggling is done at 150 megabytes per second instead of 300 megabytes per second.

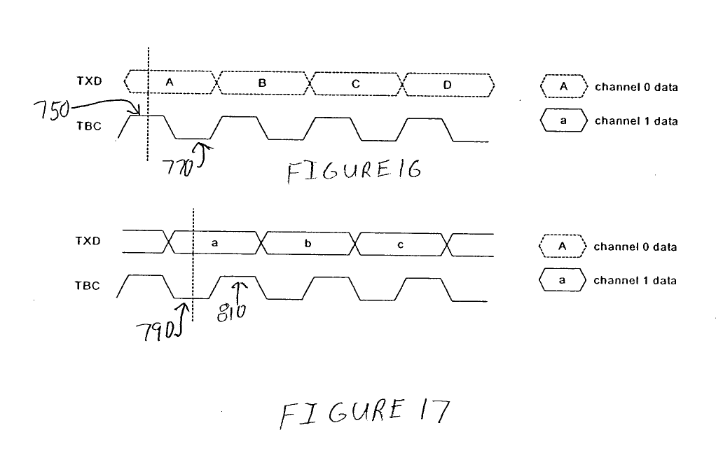

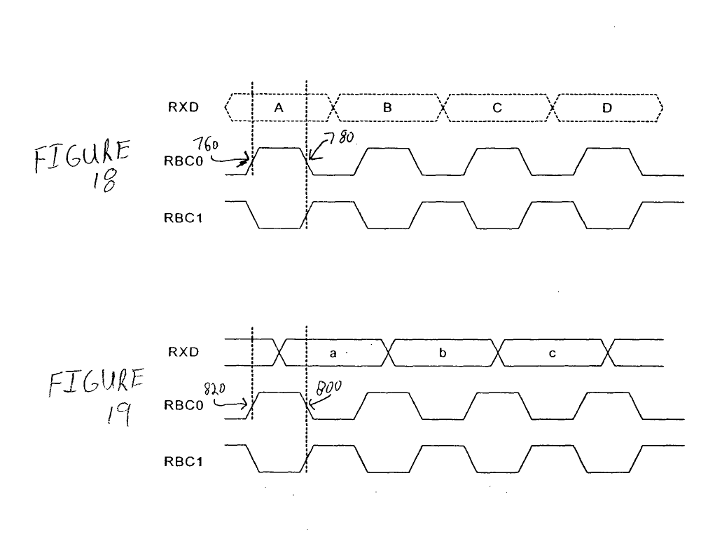

Conversely, FIGS. 17 and 19 convey the case where only channel 1 is active. Channel 1 data is sampled on the low period 790 of TBC and the falling edge 800 of RBC0. Also, instead of switching the data to nulls for channel 0 on the high period 810 of TBC or the rising edge 820 of RBC0, the TxD/RxD pins (not shown) maintain the same data as sent for channel 1. Again, toggling is done at 150 megabytes per second.

During the clock channels assigned to an inactive channel, the RX_DATA_VALID signal (see FIG. 14) will go low in the receiver to indicate that the RxD outputs are not valid data for that channel. At the data multiplexer/demultiplexer (not shown), the invalid data can be dropped in the single channel mode as it does not need to be propagated further. When both channel 0 and 1 are inactive, the data pattern is unchanged and the power consumed becomes zero. In any of the preceding cases, however, TBC, RBC0 and RBC1 keep toggling.

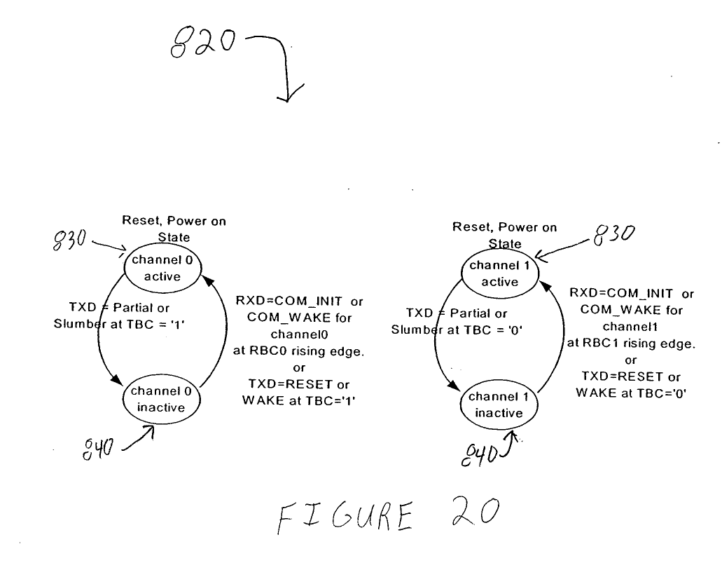

In order to realize the power savings, state machines are required for each channel. FIG. 20 illustrates a state diagram 820 for channel 0 and channel 1 active/inactive modes, in accordance with the present invention. The default state for all state machines is active mode 830. This can occur, for example, at power on or after an external RESET. When this happens, the southbridge 30 will send signals to the PHY 730 in an attempt to handshake with any connected devices. Transitions from the active mode 830 to the inactive mode 840 can be initiated from either the southbridge 30 or the PHY 730. For example, a host may initiate activity via the southbridge 30 or the PHY 730 may initiate activity due to a device being hot-plugged. Host initiated activity occurs when the southbridge 30 sends a soft RESET command or a WAKE command to the inactive channel, either one is also preceded by an OOB sequence (COM_RESET or COM_WAKE). PHY 730 initiated transitions occur when a device sends a COM_INIT or a COM_WAKE that is detected by the PHY 720 and passed along to the southbridge 30. It will be appreciated by those skilled in the art that each of the WAKE, RESET, COM_INIT and COM_WAKE commands is channel specific. When both channels are active, the SATALITE interface exchanges data in the DDR mode.

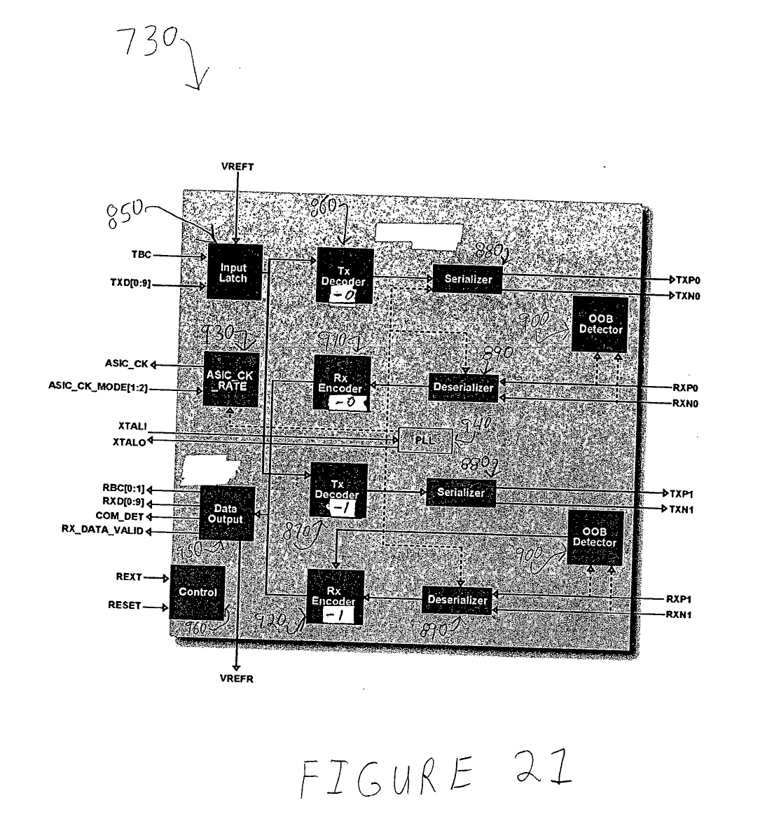

FIG. 21 is a block diagram of an SATA PHY 730, in accordance with the present invention. Included in SATA PHY 730 is an input latch 850 coupled to a Tx decoder-0 860 and a Tx decoder-1 870 both of which are coupled to serializers 880, respectively. Additionally, there are deserializers 890 coupled to OOB detectors 900. Each deserializer 890 is coupled to an Rx encoder-0 910 and an Rx encoder-1 920, respectively. Rx encoder-0 910 and an Rx encoder-1 920 are both coupled to data output 950. Phase lock loop (PLL) 940 coupled to the serializers 880, deserializers 890 and the ASIC_CK_RATE 930. PLL 940 is used for synchronizing the various system clocks contained in the SATA PHY 730. Finally control 960 is coupled to REXT and RESET inputs. It will be appreciated by one skilled in the art that many aspects of the SATA PHY 730 are a standard implementation conforming to serial ATA guidelines and Intel corporation's SAPIS (SATA PHY Interface Specification) guidelines. As such, SATA PHY 730 will not be described in exhaustive detail as to not unnecessarily obscure the present invention.

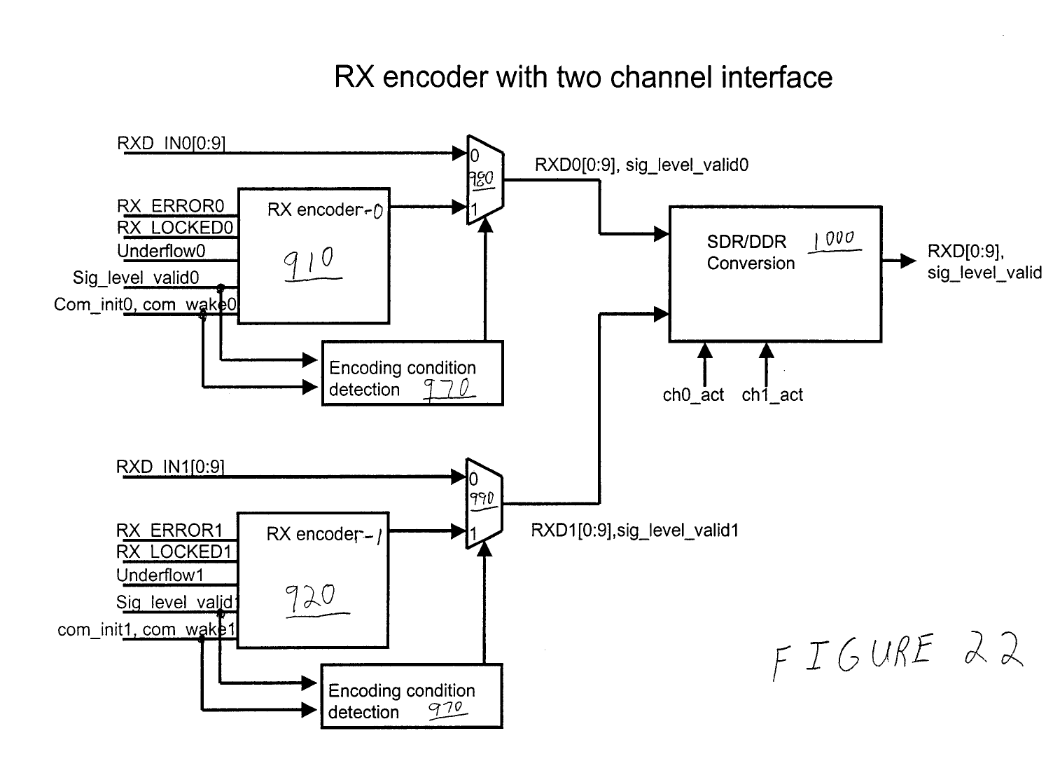

FIG. 22 is a detailed block diagram illustrating the hookup of the Rx encoders 910 and 920 with a two-channel interface, in accordance with the present invention. Rx encoder-0 910 is coupled to RX_ERROR0, RX_LOCKED0, Underflow1, Sig_level_valid0 and Com_init0/com_wake0 inputs. Sig_level_valid0 and Com_init0/com_wake0 inputs are also coupled to an encoding condition detection block 970. Outputs from Rx encoder-0 910 and encoding condition detection 970 are coupled to mux 980. Mux 980 is also coupled to RXD_IN0[0:9].

In a similar fashion, Rx encoder-1 920 is coupled to RX_ERROR1, RX_LOCKED1, Underflow1, Sig_level_valid1 and Com_init1/com_wake1 inputs. Sig_level_valid1 and Com_init1/com_wake1 inputs are also coupled to an encoding condition detection block 970. Outputs from Rx encoder-1 920 and encoding condition detection 970 are coupled to mux 990. Mux 980 is also coupled to RXD_IN1[0:9]. SDR (single data rate)/DDR (double data rate) conversion block 1000 is coupled to outputs of flipflops 980 and 990, ch0_act and ch1_act. SDR/DDR conversion block 1000 has an RXD[0:9] and sig_level_valid outputs.

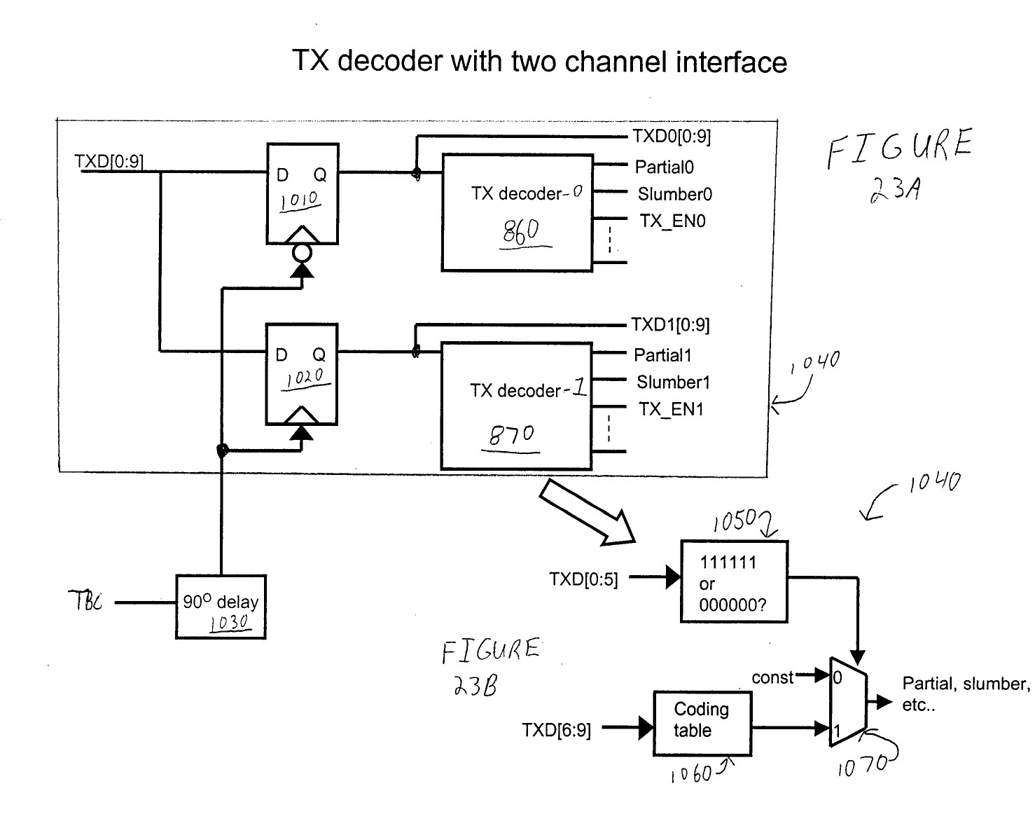

FIG. 23A is a detailed block diagram illustrating the hookup of the Tx encoders 860 and 870 with a two-channel interface, in accordance with the present invention. 90 degree delay block 1030 is coupled to a TBC input. FFs 1010 and 1020 are both coupled an output of the 90 degree delay block 1030 and TXD[0:9]. Tx decoder-0 860 is coupled to the output of FFs 1010—Txd[0:9]. Similarly, Tx decoder-1 870 is coupled to the output of multiplexer 1020—TxD1[0:9]. By delaying the TBC by 90 degrees, or one quarter of a cycle, the rising and falling edges of TBC latch Tx0 and Tx1.

FIG. 23B is a more detailed block diagram illustrating the hookup of the Tx encoders 1040, in accordance with the present invention. An error code-box 1050 outputs either “111111” or “000000” into the TxD[0:5] coding space. When either is output, it is a signal that the remaining unused coding space is to be used for additional commands. To achieve this, TxD[6:9] is coupled to a coding table 1060. Coding table 1060 contains the available commands that can be inserted into the unused coding space. The output of the coding table 1060, a constant and the output of error code-box 1050 form the inputs of flipflop 1070.

An advantage of the present invention is that serial ATA hard disk drives can be added to an existing system utilizing ATA hard disk drives without adding to the pin count of a chipset. Additionally, the present invention provides for double data rate communication to serial ATA hard disk drives and for encoding additional commands in an unused space of a coding standard.

An advantage of the present invention is that serial ATA hard disk drives can be added to an existing system utilizing ATA hard disk drives without adding to the pin count of a chipset. Additionally, the present invention provides for double data rate communication to serial ATA hard disk drives and for encoding additional commands in an unused space of a coding standard.

While this invention has been described in terms certain preferred embodiments, it will be appreciated by those skilled in the art that certain modifications, permutations and equivalents thereof are within the inventive scope of the present invention.

1. A method for multiplexing control signals for disk drives comprising:
developing parallel control signals;
developing serial control signals;
coupling at least one of the parallel control signals and the serial control signals to at least one of a parallel hard disk drive and a serial hard disk drive by a common control bus.

2. A method as recited in claim 1 wherein the first the parallel hard disk drive is an ATA type.

3. A method as recited in claim 1 wherein the serial hard disk drive is an SATA type.

4. A method as recited in claim 1 further comprising a second serial hard disk drive.

5. A method as recited in claim 4 wherein data is sent to the serial hard disk drive and the second serial hard disk drive at effectively double a base data rate.

6. A method as recited in claim 5 wherein the doubling the base data rate comprises:
developing a sampling data clock;
developing a first data stream at the base data rate;
developing a second data stream at the base data rate; and
multiplexing the first data stream to the common control bus on a rising edge of the base data clock and the second data stream to the common control bus on a falling edge of the base data clock, whereby the common control bus carries both the first data stream and the second data stream at effectively double the base data rate.

7. A method as recited in claim 1 for encoding additional commands onto the common control bus comprising:
determining at least one invalid command in used coding space of a coding standard;
determining unused coding space;
encoding the at least one invalid command in the used coding space and at least one command in the unused coding space.

8. A method as recited in claim 7 wherein the coding standard is an 8B10B (8 bit/10 bit) coding standard.

9. A method as recited in claim 8 wherein the invalid command is 111111.

10. A method as recited in claim 8 wherein the invalid command is 000000.

11. A method as recited in claims 9 or 10 wherein the invalid command occurs in a first six bits of the coding standard.

12. A method as recited in claims 9 or 10 wherein the invalid command occurs in a second bit through a seventh bit of the coding standard.

13. A method as recited in claims 9 or 10 wherein the invalid command occurs in a third bit through an eighth bit of the coding standard.

14. A method as recited in claims 9 or 10 wherein the invalid command occurs in a fourth bit through a ninth bit of the coding standard.

15. A method as recited in claims 9 or 10 wherein the invalid command occurs in a fifth bit through a tenth bit of the coding standard.

16. A method as recited in claim 6 for calibrating phases of the first data stream and the second data stream comprising:
a) choosing a phase;
b) testing to see if the phase is accurate;
c) receiving results of the testing;
d) logging the results of the testing;
e) repeating steps a) through d) for at least one more phase;
f) finding a threshold rate based on the results of the testing; and
g) dividing the threshold rate by two.

17. A disk drive controller comprising:
parallel logic developing parallel control signals;
serial logic developing serial control signals; and
a multiplexer coupling at least one of the parallel control signals and the serial control signals to a common bus.

18. A disk drive controller as recited in claim 17 further comprising:
one or more parallel hard disk drives coupled to the common bus and responsive to the parallel control signals; and
one or more serial hard disk drives coupled to the common bus and responsive to the serial control signals.

19. A hard disk drive controller as recited in claim 18 wherein the parallel hard disk drive is an ATA type.

20. A hard disk drive controller as recited in claim 18 wherein the serial hard disk drive is an SATA type.

21. A hard disk drive controller as recited in claim 18 wherein the serial control signals are sent to at least two of the one ore more serial hard disk drives at effectively double a base data rate.

22. A hard disk drive controller as recited in claim 21 wherein the doubling the base data rate comprises:
serial logic developing a sampling data clock;
serial logic developing a first data stream at the base data rate;
serial logic developing a second data stream at the base data rate; and
the multiplexer multiplexing the first data stream to the common control bus on a rising edge of the base data clock and the second data stream to the common control bus on a falling edge of the base data clock, whereby the common control bus carries both the first data stream and the second data stream at effectively double the base data rate.

23. A hard disk drive controller as recited in claim 17 for encoding additional commands onto the common bus comprising:
determining at least one invalid command in used coding space of a coding standard;
determining unused coding space;
encoding the at least one invalid command in the used coding space and at least one command in the unused coding space.

24. A hard disk drive controller as recited in claim 23 wherein the coding standard is an 8B10B (8 bit/10 bit) coding standard.

25. A hard disk drive controller as recited in claim 24 wherein the invalid command is 111111.

26. A hard disk drive controller as recited in claim 24 wherein the invalid command is 000000.

27. A hard disk drive controller as recited in claims 25 or 26 wherein the invalid command occurs in a first six bits of the coding standard.

28. A hard disk drive controller as recited in claims 25 or 26 wherein the invalid command occurs in a second bit through a seventh bit of the coding standard.

29. A hard disk drive controller as recited in claims 25 or 26 wherein the invalid command occurs in a third bit through an eighth bit of the coding standard.

30. A hard disk drive controller as recited in claims 25 or 26 wherein the invalid command occurs in a fourth bit through a ninth bit of the coding standard.

31. A hard disk drive controller as recited in claims 25 or 26 wherein the invalid command occurs in a fifth bit through a tenth bit of the coding standard.

32. A hard disk drive controller as recited in claim 22 for calibrating phases of the first data stream and the second data stream comprising:
a) choosing a phase;
b) testing to see if the phase is accurate;
c) receiving results of the testing;
d) logging the results of the testing;
e) repeating steps a) through d) for at least one more phase; and
f) finding a best sampling pointer based on the results of the testing.

33. A method for doubling a data rate on a disk drive serial bus comprising:
developing a sampling data clock;
developing a first data stream at a base data rate;
developing a second data stream at the base data rate; and
multiplexing the first data stream to a disk drive serial bus on a rising edge of the base data clock and the second data stream to the disk drive serial bus on a falling edge of the base data clock, whereby the disk drive serial bus carries both the first data stream and the second data stream at effectively double the base data rate.

34. A method as recited in claim 33 for calibrating phases of the first data stream and the second data stream comprising:
a) choosing a phase;
b) testing to see if the phase is accurate;
c) receiving results of the testing;
d) logging the results of the testing;
e) repeating steps a) through d) for at least one more phase;
f) finding a threshold rate based on the results of the testing; and
g) dividing the threshold rate by two.

35. A method as recited in claim 33 for encoding additional commands onto the disk drive serial bus comprising:
determining at least one invalid command in used coding space of a coding standard;
determining unused coding space;
encoding the at least one invalid command in the used coding space and at least one command in the unused coding space.

36. A method as recited in claim 36 wherein the coding standard is an 8B10B (8 bit/10 bit) coding standard.

37. A method as recited in claim 36 wherein the invalid command is 111111.

38. A method as recited in claim 36 wherein the invalid command is 000000.

39. A method as recited in claims 37 or 38 wherein the invalid command occurs in a first six bits of the coding standard.

40. A method as recited in claims 37 or 38 wherein the invalid command occurs in a second bit through a seventh bit of the coding standard.

41. A method as recited in claims 37 or 38 wherein the invalid command occurs in a third bit through an eighth bit of the coding standard.

42. A method as recited in claims 37 or 38 wherein the invalid command occurs in a fourth bit through a ninth bit of the coding standard.

43. A method as recited in claims 37 or 38 wherein the invalid command occurs in a fifth bit through a tenth bit of the coding standard.

44. A method for encoding additional commands in a coding standard comprising:
determining at least one invalid command in used coding space of a coding standard;
determining unused coding space;
encoding the at least one invalid command in the used coding space and at least one command in the unused coding space.

45. A method as recited in claim 44 wherein the coding standard is an 8B10B (8 bit/10 bit) coding standard.

46. A method as recited in claim 45 wherein the invalid command is 111111.

47. A method as recited in claim 45 wherein the invalid command is 000000.

48. A method as recited in claims 46 or 47 wherein the invalid command occurs in a first six bits of the coding standard.

49. A method as recited in claims 46 or 47 wherein the invalid command occurs in a second bit through a seventh bit of the coding standard.

50. A method as recited in claims 46 or 47 wherein the invalid command occurs in a third bit through an eighth bit of the coding standard.

51. A method as recited in claims 46 or 47 wherein the invalid command occurs in a fourth bit through a ninth bit of the coding standard.

52. A method as recited in claims 46 or 47 wherein the invalid command occurs in a fifth bit through a tenth bit of the coding standard.
